(19) United States
(12) Patent Application Publication
(10) Pub. No.: US 2010/0043443 A1
(43) Pub. Date: Feb. 25, 2010

(54) METHOD AND APPARATUS FOR SUPPRESSING AEROENGINE CONTRAILS

(75) Inventors: Frank G. Noppel, Cranfield (GB); Riti Singh, Cranfield (GB); Mark D. Taylor, Derby (GB)

Correspondence Address: OLIFF & BERRIDGE, PLC, P.O. BOX 320850, ALEXANDRIA, VA, 22320-4850, US

(73) Assignee: Rolls-Royce PLC, London (GB)

(21) Appl. No.: 12/450,691

(22) PCT Filed: Apr. 28, 2008
(86) PCT No.: PCT/GB2008/001517

§ 371 Date: Oct. 7, 2009

(30) Foreign Application Priority Data
May 26, 2007 (GB) 0710162.9

(51) Int. Cl. F02C 7/00

(52) U.S. Cl. 60/772; 60/39.5

(57) ABSTRACT

An aircraft comprising a gas turbine engine that exhausts a plume of gases in use, the aircraft comprises an ultrasound generator having an ultrasonic actuator and a waveguide to direct ultrasonic waves at the exhaust plume to avoid the formation of contrails.

The present invention relates to a method and apparatus for suppressing aeroengine condensation trails (contrails).

Recent climate assessments have stressed the importance of the radiative effects of contrails on global warming. Perturbations in the planetary radiation balance are enforced by the emission of greenhouse gases, aerosols, contrails and aviation induced cirrus clouds. The radiative forcing from contrails and cirrus clouds might be larger than the radiative forcing from all other aircraft emissions combined.

In U.S. Pat. No. 3,517,505 a method of suppressing contrails comprises the steps of preheating a hydroscopic material to decomposition temperatures and introducing the preheated decomposition material into the exhaust stream of said aircraft, said preheated decomposed hydroscopic material being introduced at in an amount sufficient to produce a large number of small particles to provide nuclei upon which the water produced by burning jet fuel can condense to prevent the formation of visible contrails. The decomposed hydroscopic material may be either chlorosulfonic acid or sulphur trioxide. The increased number of nuclei produces a higher number of smaller ice crystals that are not visible and can alter the radiative properties of the contrail.

U.S. Pat. No. 5,005,355 discloses a method of suppressing the formation of contrails from the exhaust of an engine operating in cold temperatures including the steps of providing a combined nucleating agent and freeze-point depressant selected from the group of water soluble monohydric, dihydric, trihydric or other polyhydric alcohols, or mixtures thereof, forming the solution into a vapour, and injecting the solution into the exhaust of the engine. The solution may include a non-corrosive surfactant. Another solution may include an organic or an inorganic nucleating agent, or mixtures thereof, in monohydric, dihydric or polyhydric alcohols, or mixtures thereof, and in addition may contain one or more surfactants. Effectively, the freezing point of water is depressed to avoid contrail formation.

These earlier attempts to suppress contrails are disadvantaged because chemicals are used and discharged into the atmosphere, the chemicals have to be transported implying a weight and space penalty, there is an engine efficiency loss due to the delivery mechanisms being in the exhaust ducts, the contrails are not suppressed with only their visibility altered and therefore the smaller contrail particles may cause global dimming. Environmental impact of chemicals prevents commercial utilisation of earlier attempts.

Therefore it is an object of the present invention to provide an aeroengine that reduces or eliminates condensation trails and/or cirrus cloud formations.

In accordance with the present invention an aircraft comprising a gas turbine engine that exhausts a plume of gases in use, the aircraft is characterised by comprising an ultrasound generator having an ultrasonic actuator and a waveguide to direct ultrasonic waves at the exhaust plume to avoid the formation of contrails.

Preferably, the ultrasound generator uses between 100 W and 10 kW.

Preferably, the ultrasound generator comprises a power amplifier/modulator.

Preferably, the aircraft comprises sensors to measure ambient temperature, pressure, and humidity.

Alternatively, the engine comprises sensors to measure engine performance parameters.

Additionally, the aircraft may comprise a contrail detector for detecting the presence of a contrail.

Preferably, the aircraft comprises a control unit that is connected to the sensors and controls any one of the power, direction and focussing of the ultrasonic generator to avoid the formation of contrails.

Preferably, the aircraft comprises an empennage and the ultrasound generator is located in the empennage.

Alternatively, the engine is surrounded by a nacelle and an ultrasound generator is located in the nacelle.

Alternatively, the engine comprises a centre-body and an ultrasound generator is located in the centre-body.

Preferably, the aircraft comprises a boom having an ultrasound generator located in its free end, the boom is movable between a stowed position and a deployed position.

Preferably, the control unit is connected to a means for moving the boom between its stowed and deployed positions.

In another aspect of the present invention there is provided a method of operating an aircraft comprising a gas turbine engine that exhausts a plume of gases in use, the aircraft is characterised by comprising an ultrasound generator having an ultrasonic actuator and a waveguide to direct ultrasonic waves at the exhaust plume, the method comprises the step of operating the ultrasound generator to avoid the formation of contrails.

Preferably, the aircraft comprises sensors to measure ambient conditions including temperature, pressure, and humidity, the method comprising the steps of determining whether a condition is sufficient to allow the formation of contrails and operating the ultrasound generator.

Additionally or instead the engine comprises sensors to measure engine performance parameters, the method comprising the step of determining whether a condition is sufficient to allow the formation of contrails and operating the ultrasound generator.

Additionally or instead the aircraft comprises a contrail detector, the method comprising the step of detecting the presence of a contrail and operating the electromagnetic radiation generator.

Alternatively, the aircraft comprises a boom having an ultrasound generator located in its free end, the method comprising the step of moving the boom between a stowed position and a deployed position for operation to avoid the formation of contrails.

The present invention will be more fully described by way of example with reference to the accompanying drawings in which:

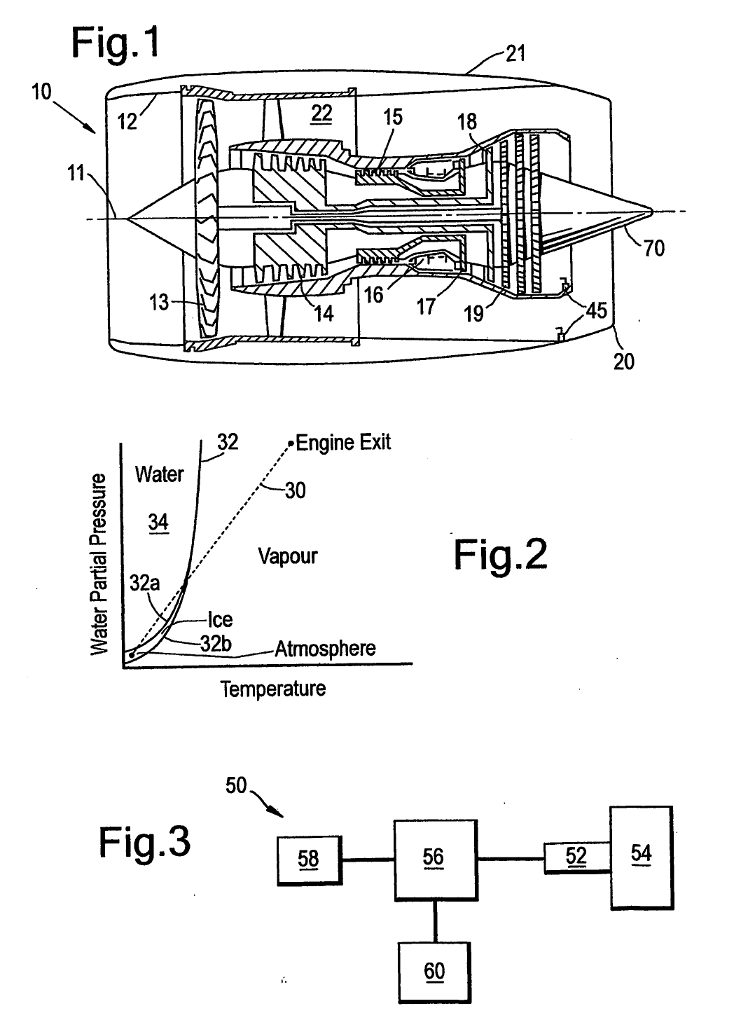

FIG. 1 is a schematic section of part of a ducted fan gas turbine engine incorporating aspects of the present invention;

FIG. 2 is a phase diagram of water showing the principle of contrail formation;

FIG. 3 is a schematic layout of components of the contrail avoidance device in accordance with the present invention;

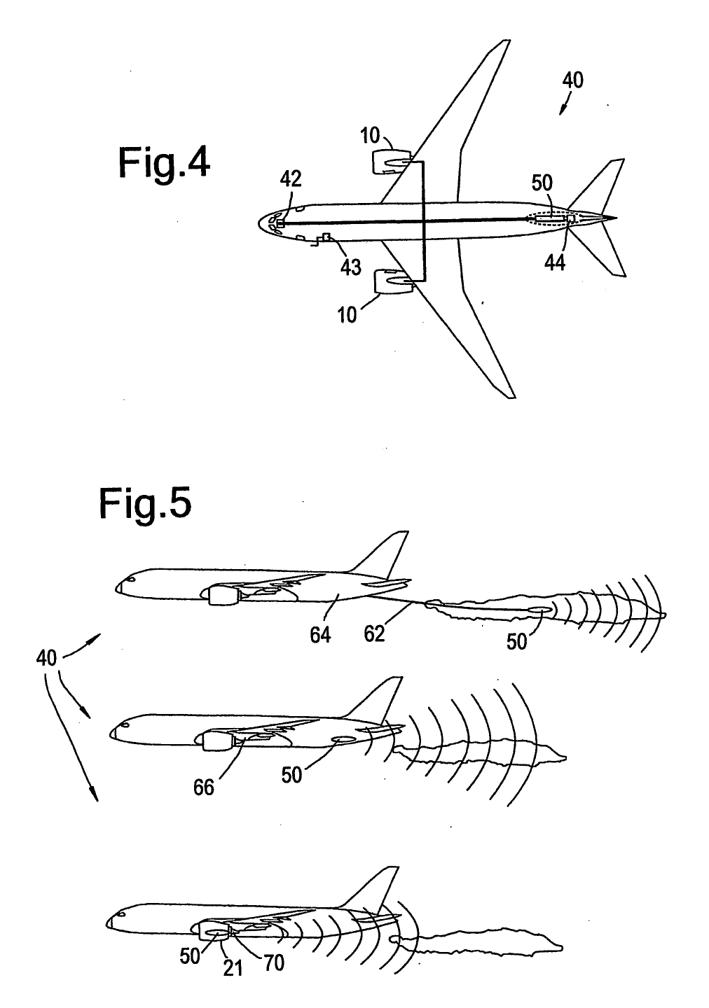

FIG. 4 is a schematic plan view of an aircraft comprising a contrail avoidance device in accordance with the present invention;

FIG. 5 show three possible configurations of an aircraft comprising the contrail avoidance device in accordance with the present invention.

With reference to FIG. 1, a ducted fan gas turbine engine generally indicated at 10 has a principal and rotational axis 11. The engine 10 comprises, in axial flow series, an air intake 12, a propulsive fan 13, an intermediate pressure compressor 14, a high-pressure compressor 15, combustion equipment 16, a high-pressure turbine 17, and intermediate pressure turbine 18, a low-pressure turbine 19 and an exhaust nozzle 20. A nacelle 21 generally surrounds the engine 10 and defines both the intake 12 and the exhaust nozzle 20.

The gas turbine engine 10 works in the conventional manner so that air entering the intake 11 is accelerated by the fan 13 to produce two air flows: a first air flow into the intermediate pressure compressor 14 and a second air flow which passes through a bypass duct 22 to provide propulsive thrust. The intermediate pressure compressor 14 compresses the air flow directed into it before delivering that air to the high pressure compressor 15 where further compression takes place.

The compressed air exhausted from the high-pressure compressor 15 is directed into the combustion equipment 16 where it is mixed with fuel and the mixture combusted. The resultant hot combustion products then expand through, and thereby drive the high, intermediate and low-pressure turbines 17, 18, 19 before being exhausted through the nozzle 20 to provide additional propulsive thrust. The high, intermediate and low-pressure turbines 17, 18, 19 respectively drive the high and intermediate pressure compressors 15, 14 and the fan 13 by suitable interconnecting shafts.

The combustion cycle of a gas turbine engine produces mainly carbon oxides and water with some nitrous and sulphur oxides. Where the atmosphere is cold enough and contains small particles, the water can form ice particles around ambient particles and engine exhaust particles such as soot, known as condensation nuclei. The mixing between the exhaust plume from the engine and the atmosphere causes super saturation with respect to water in the exhaust plume. As mixing and ice particle formation continues, the humidity of the plume diminishes (to ambient conditions).

It is understood that if the ice particles were evaporated once they have formed, condensation would not occur since the liquid phase of water is required for ice particle formation. Thus the object of the present invention is to avoid formation of contrails that occur in ice-supersaturated regions in the atmosphere.

If the atmosphere is supersaturated with respect to ice, contrails persist as long as the atmosphere is sufficiently supersaturated. On a global scale, contrails of current engines reflect incoming solar radiation to a lesser extend than they reflect terrestrial radiation, hence contributing to global warming. Due to concerns regarding the environmental impact from persistent contrails, it is desired to avoid their formation or change their radiative properties.

The principle of contrail formation is shown on a phase diagram of water in FIG. 2. Relatively warm and moist gases leave the engine. The mixing of the engine exhaust efflux and ambient air is assumed to take place adiabatically and isobarically, with temperature and humidity mixing at equal rates. In a phase diagram, this can be displayed as a straight line 30. If the line 30 crosses the area 34 for which water exist in the liquid phase, a contrail is capable of forming.

The present invention is concerned with significantly reducing or avoiding water condensation, ice particle formation, or disintegration of ice particles into smaller ones by applying ultrasound into the engine exhaust plume. Ultrasound can directly disintegrate small particles or produce cavitation inside the liquid water layer of contrail particles in their early stage, facilitating particle disintegration.

An exemplary embodiment of the present invention is shown in FIG. 3, the contrail avoidance device 50 is an ultrasound generator 50 that comprises an ultrasonic actuator 52 to generate ultrasonic waves, a waveguide 54, a power amplifier/modulator 56 and a control unit 60. Electrical power is supplied by the engines 10 or auxiliary power unit (APU) to the power amplifier/modulator 56 in the form of alternating or direct current and is transformed to a high voltage. The power amplifier/modulator 56 meters the electrical input to the ultrasonic transducer/modulator 52 that produces ultrasonic waves. The ultrasonic waves are focused by the waveguide 54 into a suitable ultrasonic wave beam for the particular plume and contrail characteristics, which may vary depending on engine and ambient conditions.

The ultrasonic waves impart energy at such a frequency as to break up solid (ice) or liquid particles or aerosols into smaller particulates. These smaller particles give the contrail different radiative properties, leading to a lower radiative forcing, thereby reducing the adverse effect of contrails mentioned in the preamble. Depending on the atmospheric conditions and exhaust plume contents and mixing therebetween, the ultrasonic waves may also vaporise water condensate, preventing condensation of water and avoid the coagulation of particles that yield large ice crystals.

It is believed that the ultrasonic generator 50 will require power in the range of some hundred Watt to some kW, which is an insignificant fraction of the engine's power to significantly reduce or completely remove contrail formation, or change their radiative properties. It should be noted that there are many different engines, which each produce different power levels and at different flight cycle conditions and allied with environmental conditions the variance of required power may be greater or less than the above exemplary range.

Referring to FIG. 4, such a contrail avoidance device communicates with the engines 10 and other avionics equipment 42 on an aircraft 40. On board sensors 43 measure the ambient temperature, pressure, and humidity. Other sensors 45 measure engine performance and are a common aspect of modern gas turbine engines and aircraft. Depending on the engine efficiency and the exhaust gas parameters, it is decided whether contrail formation is possible. In addition or alternatively, a camera 44 observes the engine plume for contrail formation. However, humidity measurements decide over whether the contrail is persistent. If the conditions for persistent contrail formation are satisfied, the contrail avoidance device 50 is switched on until measurements indicate that the formation of persistent contrails is no longer possible.

The device 50 can be installed at several locations in the aircraft 40 as shown in FIG. 5. The contrail avoidance device 50 is attached to a boom 62 so that it may be positioned directly in the engine wake where contrail formation would otherwise occur. This is advantageous in that the power required to generate the ultrasonic waves is minimised. The boom device 62 would only be deployed when necessary, otherwise it is stowable in the rear fuselage or empennage 64 of the aircraft 40. A winch or other suitable deployment means may be utilised.

One or more contrail avoidance devices 50 may also be installed in any one or more of the locations in the rear of the aircraft 40, or close to the engine 10 for example in a pylon 66 attaching the engine to the airframe, a nacelle 21 surrounding the engine or a centre-body 70 around which the exhaust efflux passes. Other positions such as the wing or fuselage may also be utilised.

The control unit 60 not only controls the ultrasound generator 50, but also deployment of the boom 62. The control unit 60 also controls the focussing and directing of the waveguide 54.

The present invention also lends itself to a method of operating the aircraft. The method comprises the step of operating the ultrasound generator 50 to avoid the formation of contrails. In particular the control unit 60 receives data from the sensors 43, which measure ambient conditions including temperature, pressure, and humidity, and compares the data to predetermined conditions known to be sufficient to allow the formation of contrails and then sends a signal to operate the ultrasound generator 50. Similarly, the method comprises reading the sensors 45 to measure engine performance parameters and determining whether a parameter is sufficient to allow the formation of contrails and operating the ultrasound generator 50. Although each of the sensor groups for ambient conditions 43 and engine parameters 45 may be used independently of one another, they may be combined to provide a check for when contrails form or a minimum level to operate the contrail avoidance device.

The method of operating an aircraft also encompasses deployment of the boom 62 and location of the ultrasound generator 50 for optimal positioning relative to the exhaust plume to avoid the formation of contrails.

In addition or alternatively, to check whether contrails are forming and operation of the ultrasound generator 50, and that it is operating optimally, a camera or other contrail detector 44 (as described in U.S. Pat. No. 5,285,256, U.S. Pat. No. 5,546,183, EP1544639) observes the engine plume for contrail formation 44. In FIG. 5, the contrail detector is conveniently located in the rear fuselage or empennage 64. The pilots having ultimate control over employment of the ultrasound generator 50 and its power output as well as the deployment of the boom 62.

The power amplifier/modulator 54 may be easily adapted to vary the amplitude and frequency of ultrasound particular requirements depending on the atmospheric conditions and exhaust plume contents and mixing therebetween. The amplitude of the sound waves is proportional of their power. More power is required for larger contrails (in terms of volume) or where there is more water in the plume (which is a function of fuel flow and ambient humidity—the more humid, the more water in the plume and the more power required). The required amplitude may also depend on the number of particles in the plume, and particle characteristics. The required frequency may also depend on particle characteristics such as size and material. It may therefore be necessary to emit sound waves having several frequencies.

It should be appreciated that several ultrasonic generators 50 may be provided on one aircraft and operated in parallel. A combination of ultrasonic generators 50 and electromagnetic wave generators, as disclosed in our co-pending UK application having the same filing date as the present application, may be used.

1-2. (canceled)

4-18. (canceled)

19. An aircraft comprising a gas turbine engine that exhausts a plume of gases in use, the aircraft is characterised by comprising an ultrasound generator having an ultrasonic actuator and a waveguide to direct ultrasonic waves at the exhaust plume to significantly reduce the formation of contrails.

20. An aircraft as claimed in claim 19 wherein the ultrasound generator uses between 100 W and 10 kW.

21. An aircraft as claimed in claim 19 wherein the ultrasound generator comprises a power amplifier/modulator.

22. An aircraft as claimed in claim 19 wherein the aircraft comprises sensors to measure ambient temperature, pressure, and humidity.

23. An aircraft as claimed in claim 19 wherein the engine comprises sensors to measure engine performance parameters.

24. An aircraft as claimed in claim 19 wherein the aircraft comprises a contrail detector for detecting the presence of a contrail.

25. An aircraft as claimed in claim 19 wherein the aircraft comprises a control unit that is connected to the sensors and controls any one of the power, direction and focussing of the ultrasonic generator to avoid the formation of contrails.

26. An aircraft as claimed in claim 19 wherein the aircraft comprises an empennage and the ultrasound generator is located in the empennage.

27. An aircraft as claimed in claim 19 wherein the engine is surrounded by a nacelle and an ultrasound generator is located in the nacelle.

28. An aircraft as claimed in claim 19 wherein the engine comprises a centre-body and an ultrasound generator is located in the centre-body.

29. An aircraft as claimed in claim 19 wherein the aircraft comprises a boom having an ultrasound generator located in its free end, the boom is movable between a stowed position and a deployed position.

30. An aircraft as claimed in claim 29 wherein the engine comprises sensors to measure engine performance parameters and wherein the control unit is connected to a means for moving the boom between its stowed and deployed positions.

31. A method of operating an aircraft comprising a gas turbine engine that exhausts a plume of gases in use, the aircraft is comprising an ultrasound generator having an ultrasonic actuator and a waveguide to direct ultrasonic waves at the exhaust plume, the method comprises the step of operating the ultrasound generator to avoid the formation of contrails.

32. A method of operating an aircraft in accordance with claim 31, wherein the aircraft comprises sensors to measure ambient conditions including temperature, pressure, and humidity, the method comprising the steps of determining whether a condition is sufficient to allow the formation of contrails and operating the ultrasound generator.

33. A method of operating an aircraft in accordance with claim 31, wherein the engine comprises sensors to measure engine performance parameters, the method comprising the step of determining whether a condition is sufficient to allow the formation of contrails and operating the ultrasound generator.

34. A method of operating an aircraft in accordance with claim 31, wherein the aircraft comprises a contrail detector, the method comprising the step of detecting the presence of a contrail and operating the ultrasound generator.

35. A method of operating an aircraft in accordance with claim 31, wherein the aircraft comprises a boom having an ultrasound generator located in its free end, the method comprising the step of moving the boom between a stowed position and a deployed position for operation to avoid the formation of contrails.
